(19) United States
(12) Patent Application Publication
(10) Pub. No.: US 2010/0287122 A1
(43) Pub. Date: Nov. 11, 2010

(54) Method Of Selling Cement To Users/Manufacturers For A Reduced Cost Through A Cement Buyers Association

(76) Inventor: Stephan E. Schuermann, (US)

Correspondence Address: DONALD J. ERSLER, S.C., 725 GARVENS AVENUE, BROOKFIELD, WI, 53005, US

(21) Appl. No.: 12/549,430

(22) Filed: Aug. 28, 2009

Related U.S. Application Data
(63) Continuation-in-part of application No. 12/542,992, filed on Aug. 18, 2009.

(30) Foreign Application Priority Data
May 7, 2009 (ZA) 2009/03149

(51) Int. Cl. G06Q 90/00

(52) U.S. Cl. 705/500

(57) ABSTRACT

A method of selling cement to users/manufacturers for a reduced cost through a cement buyers association that may include the use of a floating cement terminal. A party who desires to purchase a large quantity of cement for a reduced cost signs-up as a member of the cement buyers association and signs a purchase order for a set quantity of cement over some time period, such as a year. A joint agreement is also created between the party and a cement supplier. The supplier of the quantity of cement agrees to supply the cement for the time period and the party agrees to pay the supplier for the quantity of cement over the time period. The party at their option may receive the cement through a floating cement terminal. However, the party may also receive the cement through a safe world port of their choice.

### CROSS-REFERENCES TO RELATED APPLICATIONS

This is a continuation-in-part patent application taking priority from nonprovisional Ser. No. application 12/542,992, filed on Aug. 18, 2009, which takes priority from provisional application no. 2009/03149 filed in the South Africa patent office on May 7, 2009.

### BACKGROUND OF THE INVENTION

1. Field of the Invention

The present invention relates generally to the supplying cement and more specifically to a method of selling cement to users/manufacturers for a reduced cost through a cement buyers association, which improves the efficiency of buying and selling cement.

2. Discussion of the Prior Art

Cement manufacturers and cement suppliers experience numerous problems concerning supply of cement. Manufacturers of cement have limited supply/output capacity in each country. The reason for the limited supply is due to the fact that cement factories are designed to have a certain production or output capacity. Cement Factories/Manufacturers invest usually in the range of $85 million up to $300 million for a cement factory with an annual production capacity of approximately only 2 million metric tons. Ports may be overcrowded or too small to handle the current or increasing volumes of ships coming into or exiting the ports.

Importing and/or exporting of cement via ports or similar methods impacts dramatically on various entities relying on cost effective cement supply. For example, construction companies require cost effective and timeous supply of cement for building projects, cement manufacturers' and their shareholders profit margins are impacted through over supply or under supply of cement. Ways and means of reducing and/or normalizing logistics costs and logistics related services (shipping, trucking, rail transportation, insurance, distribution etc.) are needed.

When demand for cement in a country is high and local production cannot cope with demand, this results in importation of cement by either manufacturers, buyers, commodity traders, governments or building contractors themselves. Importation of cement to meet demand causes supply delays and pricing fluctuations due to “spot prices” and “demand shortages” influencing overall pricing. Logistics costs (port charges, shipping charges, customs duties etc.) are variable due to time constraints being unknown or variable. Once again, logistics impacts product pricing and delivery.

Shipping penalties apply to companies where ports authorities charge penalties for “missed slots” for embarking/disembarking. Limited delivery capacity both into and out of ports (trucking, trains/rail, etcetera). Logistics (trucking or related) penalties associated with “ports” pick-up and delivery timeslots are not being met (thereby increasing costs to suppliers, exporters, importers and ultimately consumers). Trucks, trains or other modes of transport/logistics to and from the Port could be “left waiting” due to a ship not having docked in a Port, but trucks or trains etcetera are already waiting. Someone is paying for these costs, which are ultimately passed on to either the cement manufacturers or ultimately the consumers. Streamlining the logistics results in increased competitive edge and pricing to consumers.

Additionally, in the countries of Nigeria, Iraq, Australia or Angola or any other country across the world with extremely high prices for Portland Cement, the local price per metric ton of cement from a factory is approximately $140-$220 per metric ton. Through applicant's direct cement mandate, cement can be provided for as low as $78 per metric ton regardless of the use of a floating cement terminal. The floating cement terminal is an added value for the members of the cement buying association especially, if the cement buying association offers a 49% co-ownership based on the fact that a member would order cement from the cement buyers association through applicant.

Accordingly, there is a clearly felt need in the art for a floating cement terminal, which provides a method of selling cement to users/manufacturers for a reduced cost through a cement buyers association, which improves the efficiency of buying and selling cement through an independent floating cement terminal.

### SUMMARY OF THE INVENTION

The present invention provides a method of selling cement to users/manufacturers for a reduced cost through a cement buyers association, which improves the efficiency of buying and selling cement. The method of selling cement to users/manufacturers for a reduced cost through a cement buyers association may or may not include the use of a floating cement terminal. However, the method of selling cement to users/manufacturers for a reduced cost through a cement buyers association does not require the use of the floating cement terminal, because of applicant's consolidated buying power and direct cement mandate for Portland Cement with an annual supply capacity of more than 500 million tons. The floating cement terminal may be docked at a location away from a busy port.

The floating cement terminal preferably includes a floating pontoon, at least one ship docking station, a cement storage warehouse, a cement packing station, a bulk cement loading station and at least one vehicle ramp. The floating pontoon is preferably fabricated from concrete. The floating pontoon is retained adjacent a land mass with a plurality of bollards positioned around a perimeter of the floating pontoon. The at least one vehicle ramp allows vehicles access to the floating pontoon from a land mass. The ship docking station is preferably located on a side opposite the at least one vehicle ramp. Each ship docking station includes at least one ship unloader. The ship unloader removes cement from a docked ship and transfers the cement to the cement storage warehouse. The cement in the cement storage warehouse is transferred to the cement packing station and the bulk cement loading station. The cement going into the cement packing station is loaded into bags for loading on to flat bed trucks. The cement going to the bulk cement loading station is transferred to a plurality of silos for loading into tanker trucks. The floating cement terminal is preferably supplied with electrical power from a self-contained electrical power source, such as solar panels, windmills or turbines. The self-contained power source may be mounted to a top of the cement storage warehouse or elsewhere on the floating pontoon.

Accordingly, it is an object of the present invention to provide a floating cement terminal, which provides cement manufacturers, commodity traders, retailers and consumers of cement with virtually unlimited access to a Portland cement supply and logistics solutions requirements for each country. Hence, cement manufacturers and interested parties can access the floating cement terminal and logistics solutions either through ordering a turnkey floating cement terminal or via a lease and/or structured joint venture agreement.

It is another object of the present invention to provide a floating cement terminal, which has an added benefit to cement buyers associated with a cement supplier that provides access to the cement supplier's direct cement mandate, which has an annual supply capacity of 500 million metric tons per year. Additional throughput of Portland cement product, which would further justify the establishment and sustainability or viability of the floating cement terminals would originate from various sources which would include, cement manufacturers/commodities traders, retailers, corporate and private entities requiring cement.

It is a further object of the present invention to provide a floating cement terminal, which provides turnkey floating cement terminals, which are for sale, lease or rent and/or accessible through a cement buyers association of each particular jurisdiction, either with or without equity ownership for the association members.

It is yet a further object of the present invention to provide a floating cement terminal, which enables cement factories not to be limited to their existing factory supply capacity, but provide access to global cement supplies at highly beneficial pricing and a cement buyers association, which is able to cater for both import and export markets along with maintaining adequate stock holdings if required.

It is yet a further object of the present invention to provide a floating cement terminal, which can be located in ports but are not solely dependent on ports and could be established “outside” of ports, which may be overcrowded or too small to handle the current or increasing volumes of ships coming into or exiting the ports.

It is yet a further object of the present invention to provide a floating cement terminal and a cement buyers association, which lowers the costs of importing and/or exporting of cement and gives its clients/members cost effective and timely supply of cement. The floating cement terminal clients and members would be cement manufacturers, construction companies, commodities traders, Governments, corporate and private clients.

It is yet a further object of the present invention to provide a floating cement terminal, which have the effect of increased profit margins to clients through a global import and export logistics and distribution solution.

It is yet a further object of the present invention to provide a floating cement terminal, which offer ways and means of reducing and/or normalizing logistics costs and logistics related services (shipping, trucking, rail transportation, insurance, distribution etc).

It is yet a further object of the present invention to provide a floating cement terminal, which helps when demand for cement in a country is high and local production cannot cope with demand, this results in importation of cement by manufacturers, buyers, commodity traders, Governments or building contractors themselves. It is yet a further object of the present invention to provide a floating cement terminal, which offers a full turnkey logistics solution for increasing capacity to all markets without any capital outlay from the local cement buyers/manufacturers side. The advantage is that the floating cement terminal can be “relocated to another country or location” when demand no longer exists thereby not having an asset which is non-income producing or not productive.

It is yet a further object of the present invention to provide a floating cement terminal, which overcomes the problem of importation of cement to meet demand and the resulting supply delays and pricing fluctuations due to “spot prices” and “demand shortages” influencing overall pricing. As of 2009, on average the prices and solutions of the floating cement terminal enable savings of $40 to $60 per metric ton or more based on the country of delivery.

It is yet a further object of the present invention to provide a floating cement terminal, which allows logistics costs (port charges, shipping charges, customs duties etc.), which are variable due to time constraints being unknown or variable to be negotiated as the pick-up and/or drop-off point is “fixed” as opposed to ships, which could be delayed from entering ports only to have trucks on standby outside a port causing delays and incurring unforeseen costs.

It is yet a further object of the present invention to provide a floating cement terminal, which eliminates shipping penalties to companies where ports authorities charge penalties for “missed slots” for embarking/disembarking.

It is yet a further object of the present invention to provide a floating cement terminal, which eliminates logistics (trucking or related) penalties associated with “ports” pick-up and delivery timeslots not being met due to delays in shipping.

It is yet a further object of the present invention to provide a floating cement terminal, which eliminates the problems of trucks, trains or other modes of transport/logistics to and from the Port that could be “left waiting” due to a ship not having docked in a port (or for other reasons for delay) but trucks or trains etcetera are already waiting. Someone is paying for these costs which are ultimately passed on to both the cement manufacturers and ultimately the consumers. Streamlining the logistics via the floating cement terminal results in increased competitive edge to cement manufacturers, commodity traders, Government, private and corporate clients along with increased competitive pricing to consumers.

It is yet a further object of the present invention to provide a floating cement terminal, which offers a global cement supply solution to cement manufacturers, cement buyers, commodity traders, government, corporate and private entities and other purchasers or consumers of cement which are active in or dependent on cement production or cement supply.

It is yet a further object of the present invention to provide a floating cement terminal, which could be established on a lake, river network, port or just “offshore,” close to the land with floating roads as access points to the floating cement terminal.

It is yet a further object of the present invention to provide a floating cement terminal and its cement buyers association offers a one stop shop logistic solution, which could be accessed by all the rival cement manufacturers thereby creating a platform for all concerned to access global markets and global cement supply capabilities without the need to compete, because the floating cement terminal is modular and expandable which results in being able to cater for all clients requirements.

It is yet a further object of the present invention to provide a floating cement terminal, which will ultimately be driven towards offering and maintaining lowest cost of logistics and supply in cement industry through, amongst others, meeting global shortage of supply capacity, resolving problems associated with limited delivery capacity into and out of ports (ships, trucking, rail, etcetera), lower insurance/port penalties, delivery and associated costs.

It is yet a further object of the present invention to provide a floating cement terminal in combination with a cement buyers association for bringing together manufacturers and/or commodity traders and/or cement buyers locally and globally thereby offering best pricing and supply solutions for all association members.

It is yet a further object of the present invention to provide a floating cement terminal, which would be of interest to at least the following entities worldwide: global cement manufacturers and factories such as Cemex, Holcim, Portland Cement, Lafarge, Heidelberg Cement and various others such as lesser known brands of cement manufacturers.

It is yet a further object of the present invention to provide a floating cement terminal, which provides exclusive and/or non-exclusive license agreements by the patent holder or its nominees with one and/or any number of parties involved in the industry globally—thereby providing either individual or collective manufacturers, suppliers, traders, distributors etc. a competitive edge in the marketplace.

It is yet a further object of the present invention to provide a floating cement terminal, which allows the supply and handling of both temporary and/or permanent peak cement demand (for both import and export), with throughput capacities of typically up to 2.5 million metric tons and expandable up to 10 million metric tons per year.

It is yet a further object of the present invention to provide a floating cement terminal, which is tied up or placed at a dock either inside, outside, adjoining or at the entry to a port and/or are provided with a floating road to “dock on” anywhere on the shore, enabling trucks to enter the floating cement terminal Island directly for pickup and loading of Portland cement.

It is yet a further object of the present invention to provide a floating cement terminal, which can be rapidly deployed; assembled; withstands waves and winds associated with coastal conditions; is 100% environmentally friendly; is a 100% dust free operation; and is virtually unsinkable and is fully relocate-able.

It is yet a further object of the present invention to provide a floating cement terminal, which has a very low draft that allows ships to enter ports very easily compared to bulk cement carriers that have deep drafts, limited storage capacity and are difficult for entering certain ports.

It is yet a further object of the present invention to provide a floating cement terminal, which can be operated without any shore facilities for transporting cement directly trucks or rail cars.

It is yet a further object of the present invention to provide a floating cement terminal, which integrated packers, bulk cement and bagged cement facilities.

It is yet a further object of the present invention to provide a floating cement terminal, which includes immediate start-up, without land lease, purchase requirements and/or construction permission.

It is yet a further object of the present invention to provide a floating cement terminal, which provides major benefits to cement factories and cement buyers of not requiring charter costs, because the floating cement terminal can deliver directly to clients any amount of Portland Cement they require.

It is yet a further object of the present invention to provide a floating cement terminal, which provides instant access to additional cement supply capacity and eliminates the waiting times for cargo ships to arrive, which is usually 30 to 45 days.

It is yet a further object of the present invention to provide a floating cement terminal, where the supplier of cement agrees to supply a quantity of cement for a time period and a party agrees to pay the supplier for the quantity of cement over the time period. The party receives a non-controlling ownership interest of up to 49% in a floating cement terminal through which the cement is supplied.

Finally, it is another object of the present invention to provide a floating cement terminal, which can accommodate office buildings and apartment blocks for staff housing inclusive of facilities for employees.

These and additional objects, advantages, features and benefits of the present invention will become apparent from the following specification.

### BRIEF DESCRIPTION OF THE DRAWINGS

FIG. 1 is a top view of a floating cement terminal in accordance with the present invention.

FIG. 2 is an enlarged end view of a ship docking station of a floating cement terminal in accordance with the present invention.

FIG. 3 is an enlarged top view of a ship docking station of a floating cement terminal in accordance with the present invention.

FIG. 4 is an enlarged front view of a vertical bucket conveyor for transferring cement from a ship unloader to a cement storage warehouse in accordance with the present invention.

FIG. 5 is a top view of a cement storage warehouse of a floating cement terminal in accordance with the present invention.

FIG. 6 is an end view of a floating cement terminal in accordance with the present invention.

FIG. 7 is a front view of a floating cement terminal without the packing station, but including a bulk cement loading station in accordance with the present invention.

FIG. 8 is an enlarged end view of a bulk cement vertical elevator and a cement storage warehouse of a floating cement terminal in accordance with the present invention.

FIG. 9 is an enlarged end view of a cement packing station of a floating cement terminal in accordance with the present invention.

### DETAILED DESCRIPTION OF THE PREFERRED EMBODIMENTS

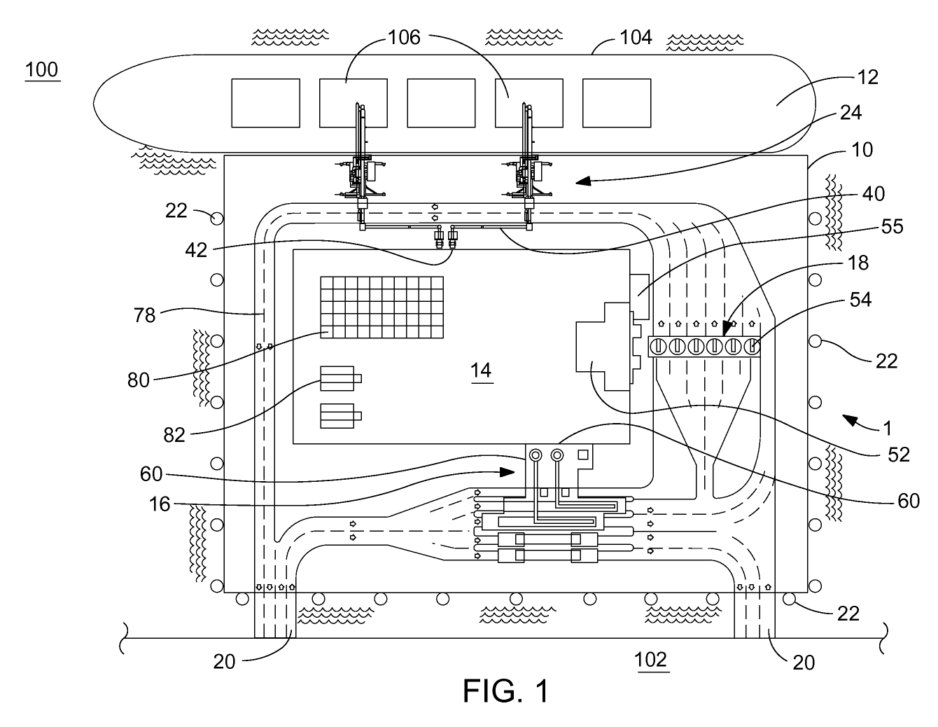

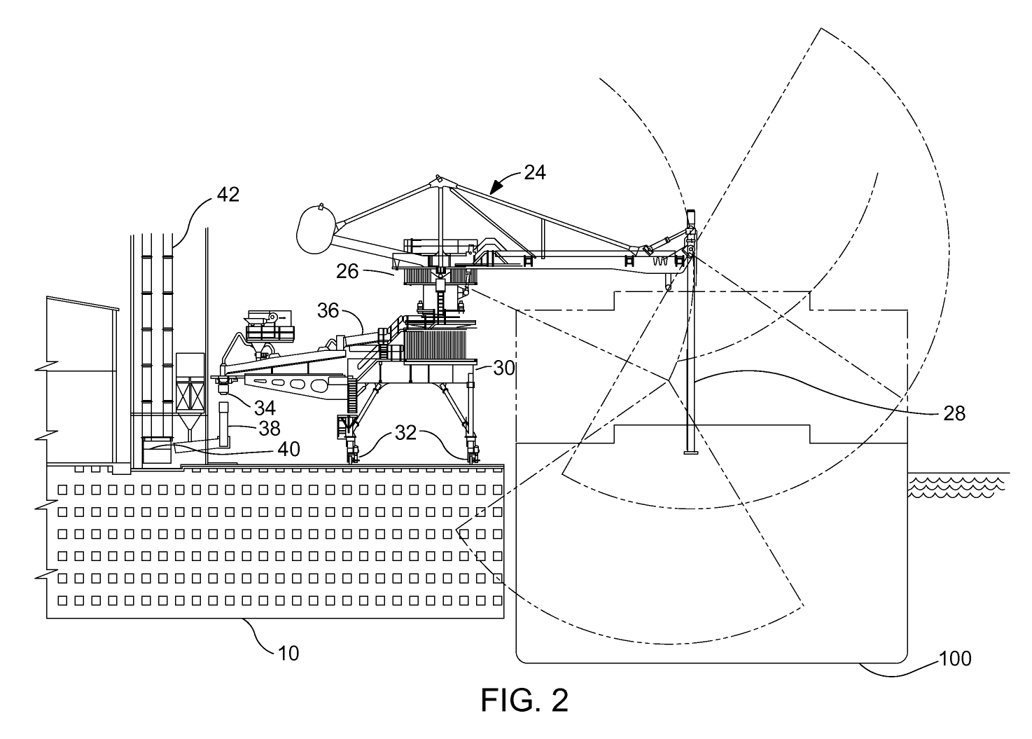

The method of selling cement to users/manufacturers for a reduced cost through a cement buyers association includes the use of a floating cement terminal 1. With reference now to the drawings, and particularly to FIG. 1, there is shown a top view of a floating cement terminal 1. With reference to FIG. 2, the floating cement terminal 1 preferably includes a floating pontoon 10, at least one ship docking station 12, a cement storage warehouse 14, a cement packing station 16, a bulk cement loading station 18 and at least one vehicle ramp 20. The floating pontoon 10 is preferably fabricated from concrete for floating in a body of water 100. The floating pontoon 10 acts as a platform for the floating cement terminal 1. The floating pontoon 10 may be purchased from International Marine Floating Structures, www.floatingstructures.com. The floating pontoon 10 is retained on a body of water and adjacent a land mass 102, preferably with a plurality of bollards 22 positioned around a perimeter of the floating pontoon 10. The at least one vehicle ramp 20 allows vehicles access to the floating pontoon 10 from the land mass 102.

The ship docking station 12 is preferably located on a side opposite the at least one vehicle ramp 20. Each ship docking station 12 includes at least one ship unloader 24. The ship unloader 24 removes cement from a cargo area 106 of a docked ship 104. The ship unloader 24 preferably includes a pivoting crane member 26, a vertical screw conveyor 28, a support base 30, roller supports 32 and a retractable loading chute 34. The pivoting crane 26 is retained on a top of the support base 30. The roller supports 32 extend from a bottom of the support base 30. The retractable loading chute 34 extends from an end of the support base 30. The vertical screw conveyor 28 draws cement from the cargo area 106. The cement is transferred through the pivoting crane member 26 to a transfer chute 36. The transfer chute 36 moves the cement to the retractable loading chute 34. The ship unloader is preferably purchased from IBAU Hamburg, www.ibauhamburg.com, but other ship unloaders may also be used.

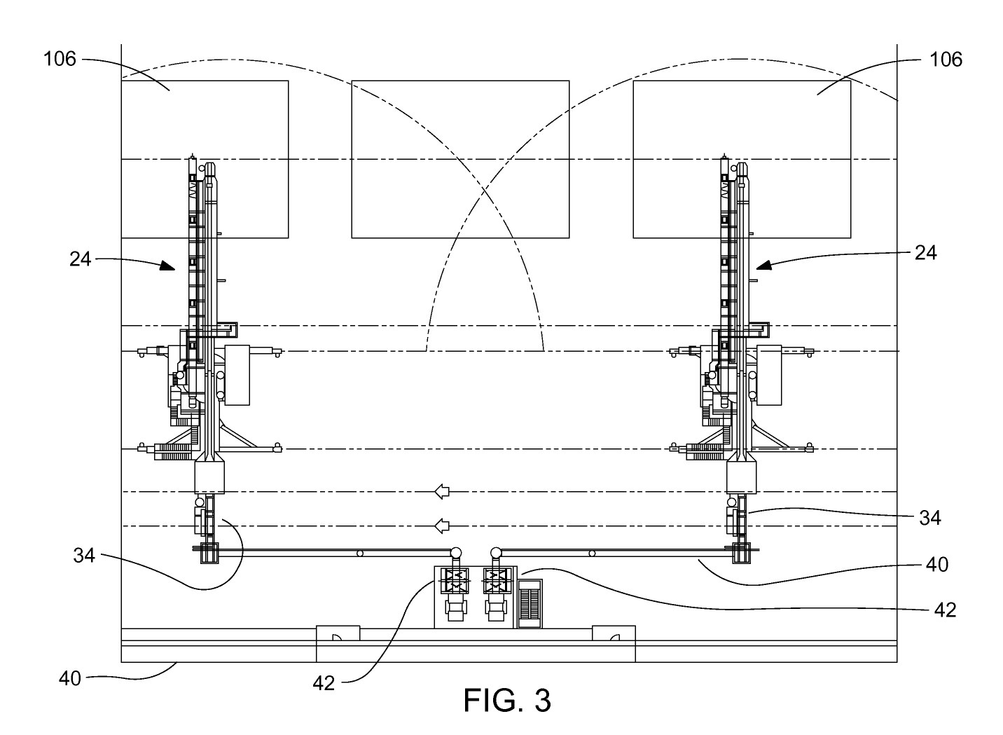

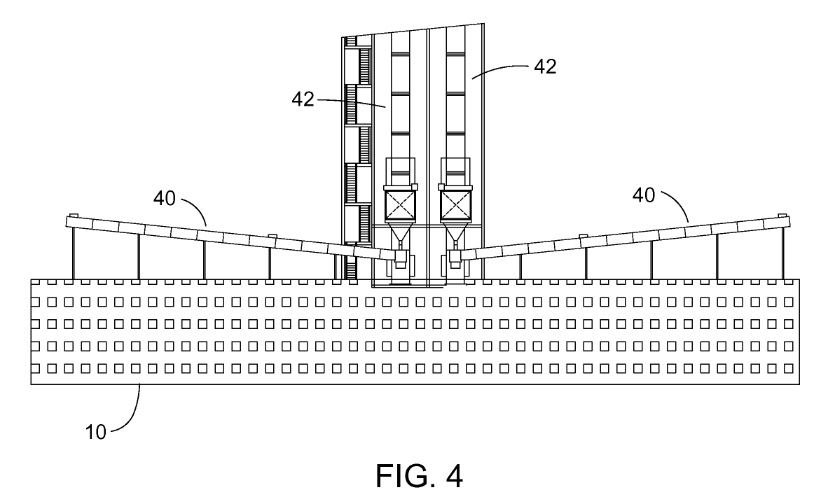

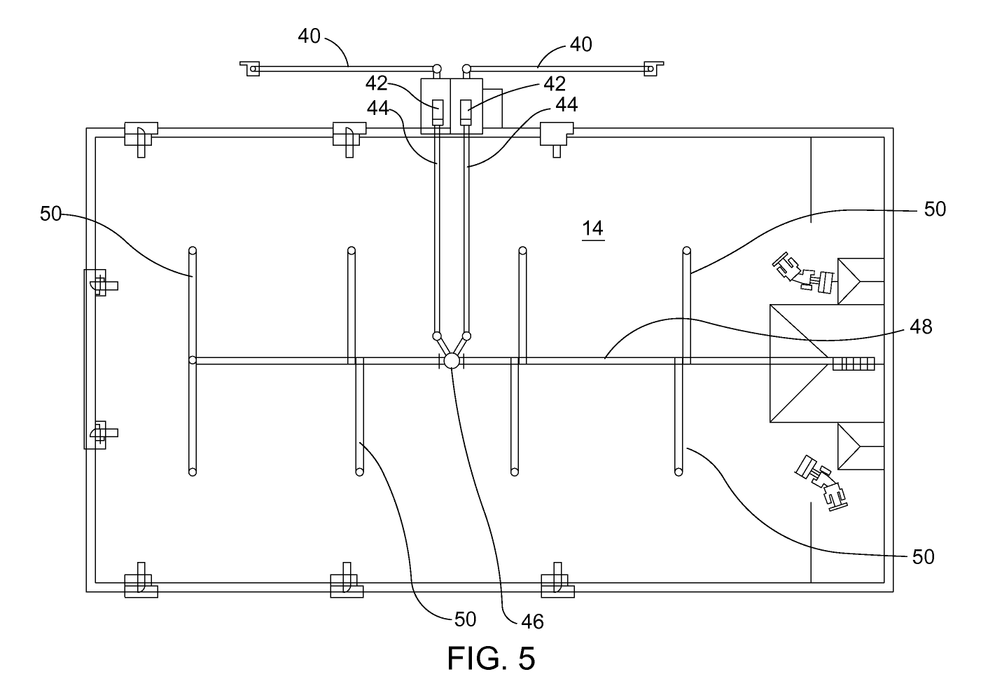

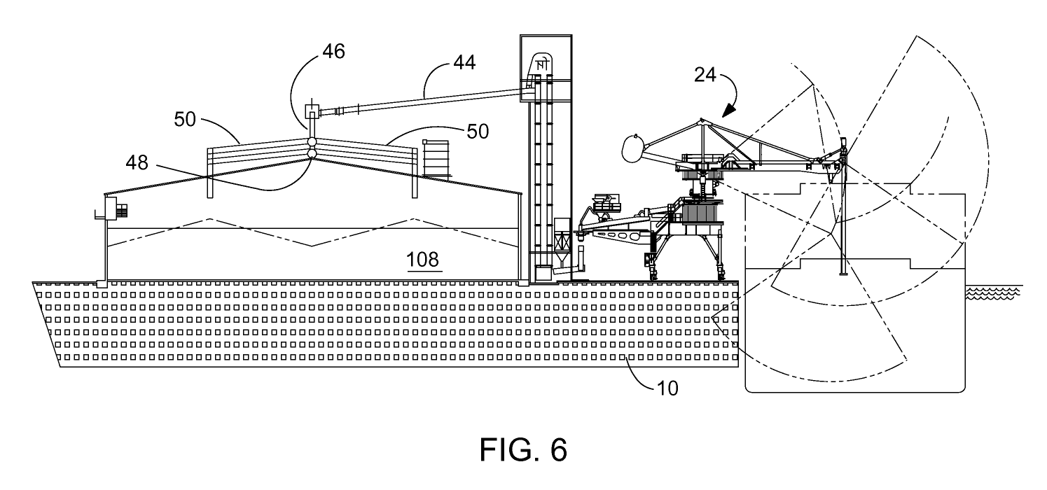

With reference to FIGS. 3-6, the cement from the retractable loading chute 34 is received by a docking receiver 38 extending from a fluid slide 40. The fluid slides 40 transfer the cement from a docking receiver 38 to a bottom of a pair of bucket elevators 42. The cement from the pair of bucket elevators 42 is transferred to a pair of warehouse fluid slides 44. The cement in the pair of warehouse fluid slides 44 empties into a gravity fluid slide 46. The cement in the gravity slide 46 empties into a manifold fluid slide 48. The manifold fluid slide 48 distributes the cement to the cement storage warehouse 14 through a plurality of distribution fluid slides 50.

The cement 108 is retained in the cement storage warehouse 14 for transfer to the cement packing station 16 and the bulk cement loading station 18. However, other cement storage structures besides the cement storage warehouse 14 may be used, such as central cone silos, cement silos, multi-compartment silos or any other appropriate cement storage structure.

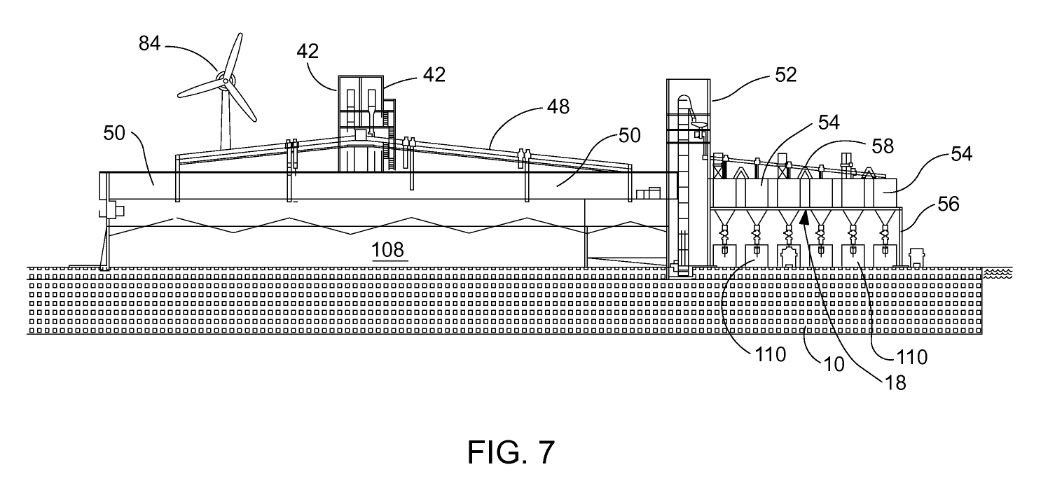

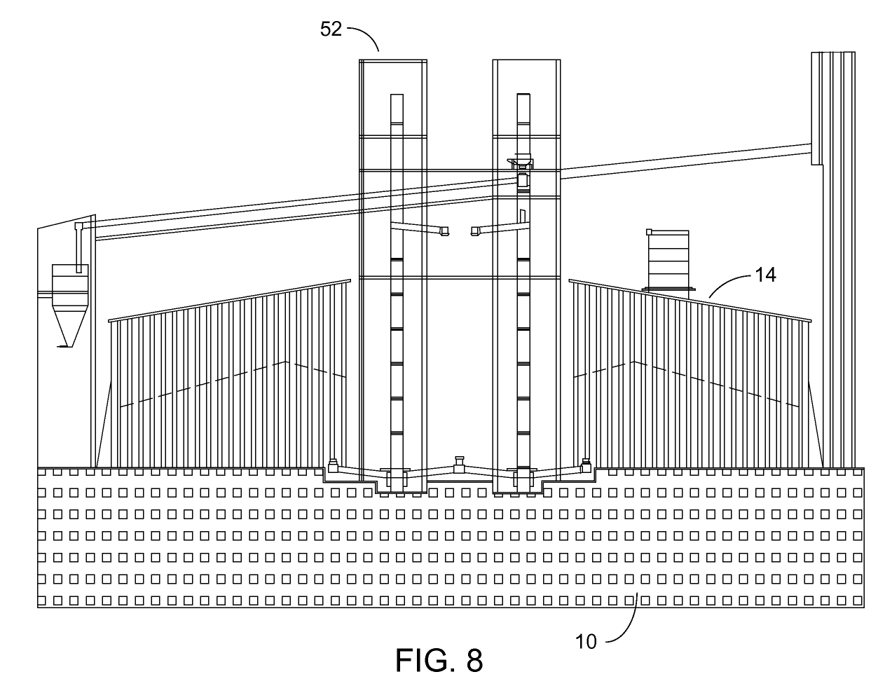

With reference to FIGS. 1, 7 and 8, the bulk cement loading station 18 preferably includes a plurality of cement silos 54 and a silo support structure 56. At least one bulk cement vertical elevator 52 transfers cement 108 in the cement storage warehouse 14 to a distribution manifold 58 positioned above the plurality of cement silos 54. The cement in the distribution manifold 58 falls into the plurality of silo cement silos 54. The silo support structure 56 suspends the plurality of cement support silos 54 above the ground, such that tank trucks 110 may be filled with bulk cement. The bulk cement loading station 18 is supplied with electrical power through switchboards/generators 55.

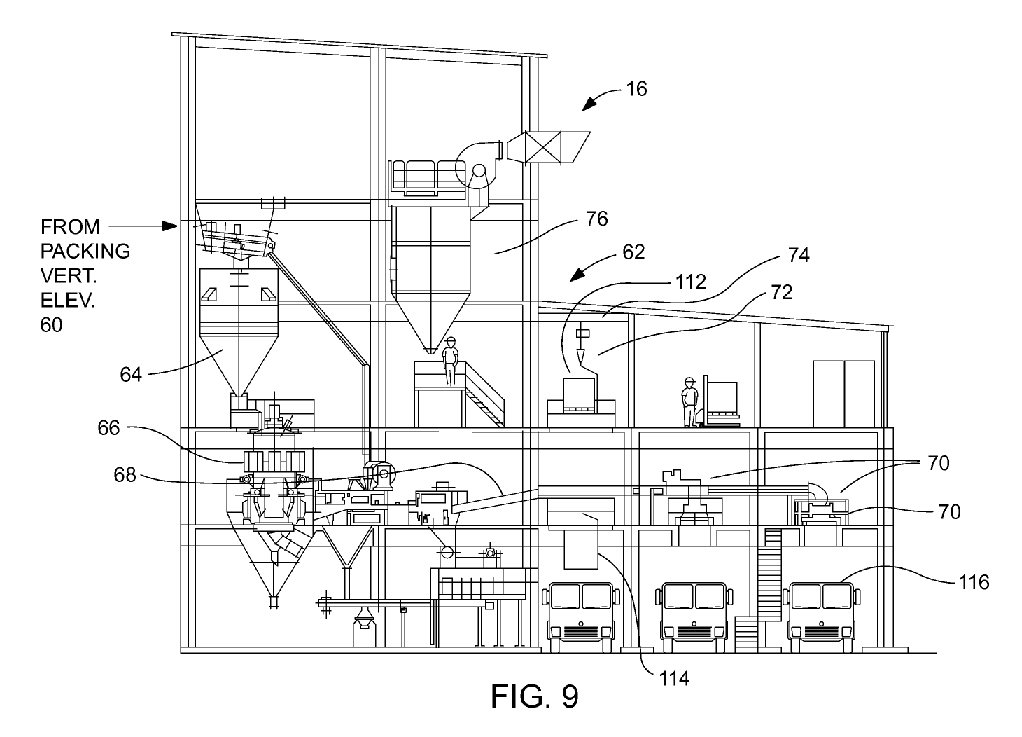

With reference to FIGS. 1 and 9, the cement packing station 16 preferably includes at least one packing vertical elevator 60 and a packing facility 62. The packing facility 62 includes a packing cement silo 64, a cement packing machine 66, a conveyor system 68, at least one filled bag lifting device 70. Each packing vertical elevator 60 takes cement 108 from the cement storage warehouse 14 and transfers the cement 108 to the packing cement silo 64.

Cement 108 in the packing cement silo 64 drops to the cement packing machine 66. The cement packing machine 66 fills empty bags 112 are with the cement 108. An empty bag lifting system 72 lifts the empty bags 112 and transfers them to the cement packing machine 66 through a rail system 74. The conveyor system 68 transfers the filled cement bags 114 from the cement packing machine 66 to one of the at least one filled bag lifting device 70. The filled bag lifting device 70 lowers the filled cement bags 114 on to a flat bed truck 116 or the like. A dedusting system 76 removes dust from the packing facility.

A roadway 78 allows trucks to travel around the floating cement terminal 1. The floating cement terminal 1 is preferably supplied with electrical power from a self-contained electrical power source, such as solar panels 80, turbines 82 or windmills 84. The self-contained power source may be mounted to a top of the cement storage warehouse 14 and/or on any suitable area of the floating cement terminal 1.

A party who desires to purchase a large quantity of cement for a reduced cost signs-up as a member of the cement buyers association and signs a purchase order for a set quantity of cement over some time period, such as a year. A joint agreement is also created between the party and a cement supplier, such as 21st Equity Group who is direct Mandate Holder for Portland Cement with an annual supply capacity of more than 500 million metric tons.

The supplier of the quantity of cement agrees to supply the cement for the time period and the party agrees to pay the supplier for the quantity of cement over the time period. The party at their option can receive a non-controlling ownership interest of up to 49% in a floating cement terminal through, which the cement would be supplied. However, the party may also receive the cement through a safe world port of their choice. The party will pay a slightly higher price for the first time period, if the party chooses delivery through a floating cement terminal. The slightly higher price for the cement, (which is usually lower priced than from local suppliers in any particular country) in the first time period is used to finance the cost of the floating cement terminal.

Additionally, the cement buyers association (CBA) and the floating cement terminal have additional benefits. Assuming in year one, a total of 2 million metric tons of cement has been consolidated with members of the CBA and the floating cement terminal has been financed and is usually debt free after about 6-12 months. Due to the co-ownership of floating cement terminal and the profit sharing agreement of 49% on the floating cement terminal, each member of the CBA can use the floating cement terminal for their own cement supply and/or make the floating cement terminal a profit center for at least 25 years. Each member can sell cement to other buyers within the country and earn $10 to $20 per metric ton.

For example, Iraq cement manufacturers charge $220per metric ton. The CBA can import cement for $78 per metric ton and charge in year one only $98 per metric ton to CBA members for 2 million metric tons which results in a $20×2 million=$40 million profit, which 100% finances the floating cement terminal and makes the floating cement terminal debt free after 6 months. In year 2, a supplier (such as 21st Equity Group) and the CBA members who now co-own 49% of the cement floating terminal can decide to further import cement into Iraq for the suppliers use or CBA member's use and/or sell it to local buyers for $98 per metric ton and make a profit of $40 million profit for each year. Moreover, the local buyers of the cement still save $122 per metric ton, which is a no brainer for everyone who needs cement.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of selling cement to a party for a reduced cost through a cement buyers association, comprising the steps of:
having a party become a member of a cement buyers association;
having the party sign a purchase order for a quantity of cement for a period of time;
creating a joint agreement between the party and a cement supplier;
having a supplier of cement agree to supply the quantity of the cement for said period of time; and
having the party agree to pay the supplier for the quantity of cement over said period of time.

2. The method of selling cement to a party for a reduced cost through a cement buyers association of claim 1, further comprising the step of:
anchoring a floating cement terminal adjacent a land mass, the quantity of cement being supplied through said floating cement terminal.

3. The method of selling cement to a party for a reduced cost through a cement buyers association of claim 2, further comprising the step of:
providing the party with a non-controlling ownership interest and a profit sharing agreement of up to 40% in said floating cement terminal.

4. The method of selling cement to a party for a reduced cost through a cement buyers association of claim 3, further comprising the step of:
providing the party with a lower price for the quantity of cement following said period of time.

5. The method of selling cement to a party for a reduced cost through a cement buyers association of claim 4, further comprising the step of:
providing a higher price for the quantity of cement in a first period of time to finance the cost of said floating cement terminal, but keeping the price for the quantity of cement below that of local suppliers.

6. The method of selling cement to a party for a reduced cost through a cement buyers association of claim 2, further comprising the step of:
providing a floating pontoon as a platform for said floating cement terminal.

7. The method of selling cement to a party for a reduced cost through a cement buyers association of claim 2, further comprising the step of:
providing at least one ship docking station on said floating cement terminal, said at least one ship docking station removing the quantity of cement from a ship.

8. The method of selling cement to a party for a reduced cost through a cement buyers association of claim 2, further comprising the step of:
providing a cement storage warehouse for storing the quantity of cement supplied from said at least one ship docking station.

9. The method of selling cement to a party for a reduced cost through a cement buyers association of claim 8, further comprising the step of:
providing at least one station for loading the quantity of cement into vehicles, the quantity of cement being transferred from said storage warehouse to said at least one station.

10. A method of selling cement to a party for a reduced cost through a cement buyers association, comprising the steps of:
having a party become a member of a cement buyers association;
having the party sign a purchase order for a quantity of cement for a period of time;
creating a joint agreement between the party and a cement supplier;
having a supplier of cement agree to supply the quantity of the cement for said period of time, said supplier having an annual supply capacity of at least 500 million metric tons per year; and
having the party agree to pay the supplier for the cement over said period of time.

11. The method of selling cement to a party for a reduced cost through a cement buyers association of claim 10, further comprising the step of:
anchoring a floating cement terminal adjacent a land mass, the quantity of cement being supplied through said floating cement terminal.

12. The method of selling cement to a party for a reduced cost through a cement buyers association of claim 11, further comprising the step of:
providing the party with a non-controlling ownership interest and a profit sharing agreement of up to 49% in said floating cement terminal.

13. The method of selling cement to a party for a reduced cost through a cement buyers association of claim 10, further comprising the step of:
providing the party with a lower price for the quantity of cement following said period of time.

14. The method of selling cement to a party for a reduced cost through a cement buyers association of claim 11, further comprising the step of:
providing a higher price for the quantity of cement in a first period of time to finance the cost of said floating cement terminal, but keeping the price for the quantity of cement below that of local suppliers.

15. The method of selling cement to a party for a reduced cost through a cement buyers association of claim 11, further comprising the step of:
providing a floating pontoon as a platform for said floating cement terminal.

16. The method of selling cement to a party for a reduced cost through a cement buyers association of claim 11, further comprising the step of:
providing at least one ship docking station on said floating cement terminal, said at least one ship docking station removing the quantity of cement from a ship.

17. The method of selling cement to a party for a reduced cost through a cement buyers association of claim 11, further comprising the step of:
providing a cement storage warehouse for storing the quantity of cement supplied from said at least one ship docking station.

18. A method of selling cement to a party for a reduced cost through a cement buyers association, comprising the steps of:
having a party become a member of a cement buyers association;
having the party sign a purchase order for a quantity of cement for a period of time;
creating a joint agreement between the party and a cement supplier;
having a supplier of cement agree to supply the quantity of cement for said period of time;
having the party agree to pay the supplier for the quantity of cement over said period of time; and
anchoring a floating cement terminal adjacent a land mass, the quantity of cement being supplied through said floating cement terminal.

19. The method of selling cement to a party for a reduced cost through a cement buyers association of claim 18, further comprising the step of:
providing the party with a non-controlling ownership interest and a profit sharing agreement of up to 49% in said floating cement terminal.

20. The method of selling cement to a party for a reduced cost through a cement buyers association of claim 18, further comprising the step of:
providing the party with a lower price following said period of time.
